(19) United States
(12) Patent Application Publication
(10) Pub. No.: US 2009/0255169 A1
(43) Pub. Date: Oct. 15, 2009

(54) Finesse Head Fishing Lure

(76) Inventors: Richard Lowitzki, St Charles, IL (US); Jimmy Millsaps, Canton, GA (US)

Correspondence Address: Kathleen K. Bowen Co., LPA, 311 Hillbrook Dr, Cuyahoga Falls, OH, 44223, US

(21) Appl. No.: 12/249,918

(22) Filed: Oct. 11, 2008

Related U.S. Application Data
(60) Provisional application No. 60/979,092, filed on Oct. 11, 2007.

(51) Int. Cl. A01K 85/00

(52) U.S. Cl. 43/42.37

(57) ABSTRACT

A finesse head fishing lure comprises a head, which is relatively spherical, having a relatively spherical surface. The head comprises four hemispheres, a top hemisphere, and an opposing bottom hemisphere, wherein the top and bottom hemispheres are divided by a first plane, and a front hemisphere, and an opposing back hemisphere wherein the front and back hemispheres are divided by a second plane. The head has a recess in the top hemisphere. The head also comprises a fishing hook having an eye, a body, and a hook portion. The fishing hook is integral to the head, such that the eye is exposed in the head recess. The recess is sized such that the eye is flush with the head surface, or slightly recessed therefrom, and further such that there is room around the eye such that a fishing line may be secured to the eye. The hook portion is on the same side of the first plane as the eye.

### CROSS REFERENCE TO RELATED APPLICATIONS

This application claims the benefit of U.S. Provisional Application No. 60/979092, filed Oct. 11, 2007.

### BACKGROUND

The present invention is in the field of fishing lures. More specifically this invention relates to the finesse head type fishing lure, also referred to as a shaky-head lure.

### BRIEF DESCRIPTION OF DRAWINGS

FIG. 1 is an isometric view of a finesse head fishing lure according to an aspect of the invention.

FIG. 2 is a partial isometric view of a finesse head fishing lure according to an aspect of the invention.

FIG. 3 is an end view of a finesse head fishing lure according to an aspect of the invention.

FIG. 4 is a partial isometric view of a finesse head fishing lure according to an aspect of the invention.

### DETAILED DESCRIPTION

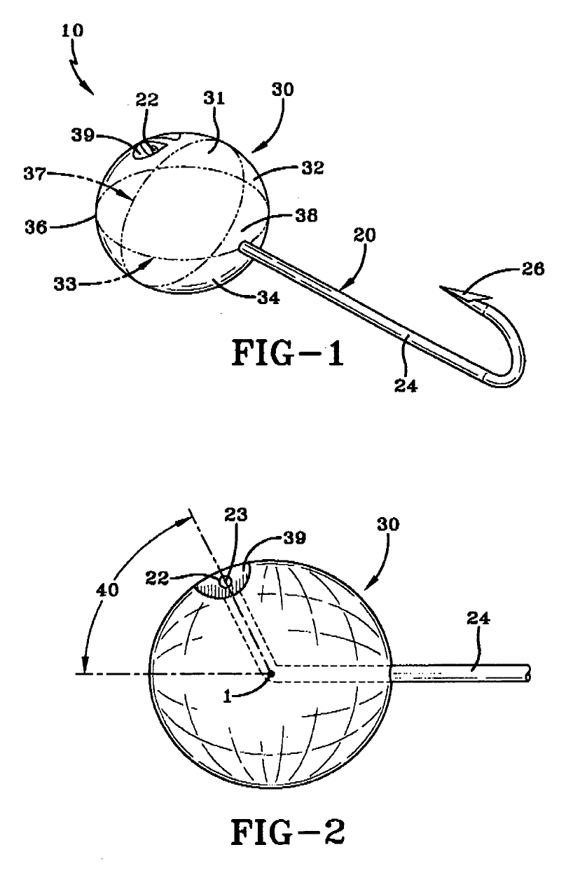

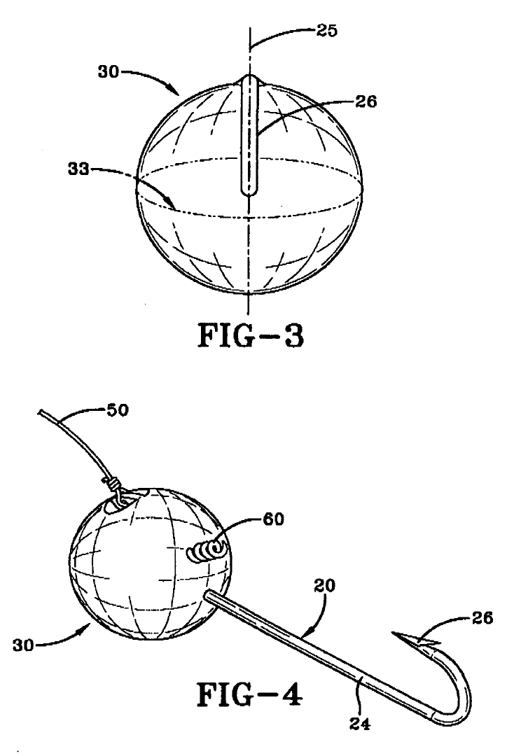

Various aspects of the invention are presented in FIGS. 1-6 which are not drawn to scale and in which like components are numbered alike. Referring now to FIGS. 1-3, according to an aspect of the invention, a finesse head fishing lure 10 is shown. The finesse head fishing lure 10 is comprised of a head 30, and a fishing hook 20.

According to an aspect of the invention, the head 30 is relatively spherical, having a relatively spherical surface 31. The head 30 comprises four hemispheres, a top hemisphere 32, and an opposing bottom hemisphere 34, wherein the top and bottom hemispheres 32/34 are divided by a first plane 33; and a front hemisphere 36, and an opposing back hemisphere 38 wherein the front and back hemispheres 36/38 are divided by a second plane 37. The head 30 has a recess 39 in the top hemisphere 32. During use, a finesse head lure typically is pulled along, or close to the bottom surface of the body of water being fished. The top hemisphere 32 roughly corresponds to the side of the head 30 which would be facing away from the bottom surface. Further, the front hemisphere 36 roughly corresponds to the side of the head 30 which faces the direction the lure is being pulled.

The fishing hook 20 has an eye 22, a body 24, and a hook portion 26. The fishing hook 20 is integral to the head 30, such that the eye 22 is exposed in the head recess 39, and the body extends from the head 30. The recess 30 is sized such that the eye 22 is flush with the head surface 31, or slightly recessed therefrom, and further such that there is room around the eye 22 such that a fishing line 50 may be secured to the eye 22. Further, the hook portion 26 is on the same side of the first plane 33 as the eye 22.

According to a further aspect of the invention, the fishing hook body 24 extends from the head 30 from the back hemisphere 38, such that the body 24 is relatively parallel to the first plane 33.

According to another aspect of the invention, the fishing hook body 24 extends from the head 30 from the back hemisphere 38, such that the body 24 lies relatively along the first plane 33.

If the connection point of the eye 22 to the hook body 24 is point 1, and a line is drawn from this point through the center 23 of the eye 22, the angle between that line, and a line along the hook body is the eye angle of attachment 40. According to an aspect of the invention, this angle is approximately 90°. According to a further aspect of the invention, this angle may be between 45° and 90°.

According to another aspect of the invention, the recess 39 is located in the top hemisphere 32 and the front hemisphere 36.

In another aspect of the invention, the hook portion 26 lies in a plane, herein called the hook plane 25, and the hook plane 25 is relatively perpendicular to the first plane 33. The eye 22 may also lie in the hook plane 25.

According to a further aspect of the invention, the finesse head lure may also comprise an attachment aid 60 protruding from the head 30. According to an aspect of the invention, this attachment aid 60 protrudes from the back hemisphere 38 on the same side of the first plane 33 as the hook portion 26.

The invention has herein been describes with a relatively spherical head. It is understood that a slightly different shape, such as a football shape, or an egg shape is also within the purview of this invention, as long as the relative spacing of the hook elements, and the eye hiding recess are present.

We claim:

1. A finesse head fishing lure comprising:
a head, wherein said head is relatively spherical, having a relatively spherical surface, wherein said head comprises four hemispheres, a top hemisphere, and an opposing bottom hemisphere, wherein said top and bottom hemispheres are divided by a first plane, and a front hemisphere, and an opposing back hemisphere wherein said front and back hemispheres are divided by a second plane, further wherein said head has a recess in said top hemisphere; and,
a fishing hook, wherein said fishing hook has an eye, a body, and a hook portion, wherein said fishing hook is integral to said head, such that said eye is exposed in said head recess, and said recess is sized such that said eye is flush with the head surface, or slightly recessed therefrom, and further such that there is room around said eye such that a fishing line may be secured to said eye, further, wherein said hook portion is on the same side of said first plane as said eye.

2. The finesse head fishing lure of claim 1 wherein said fishing hook body extends from said head from said back hemisphere, such that said body is relatively parallel to said first plane.

3. The finesse head fishing lure of claim 1 wherein said fishing hook body extends from said head from said back hemisphere, such that said body lies relatively along said first plane.

4. The finesse head fishing lure of claim 1 wherein said eye makes approximately a 90° angle with said fishing hook body.

5. The finesse head fishing lure of claim 1 wherein said eye makes an angle between 45° and 90° with said fishing hook body.

6. The finesse head fishing lure of claim 1 wherein said recess is located in said top hemisphere and said front hemisphere.

7. The finesse head fishing lure of claim 1 wherein said hook portion lies in a plane, herein called the hook plane, and wherein said hook plane is relatively perpendicular to said first plane.

8. The finesse head fishing lure of claim 7 wherein said eye also lies in said hook plane.

9. The finesse head fishing lure of claim 1 wherein said hook portion lies in a plane, herein called the hook plane, and wherein said eye also lies in said hook plane.
